(19) United States
(12) Patent Application Publication
(10) Pub. No.: US 2021/0009850 A1
(43) Pub. Date: Jan. 14, 2021

(54) POLYURETHANE POWDER COATING MATERIAL

(71) Applicant: Covestro Intellectual Property GmbH & Co. KG, Leverkusen (DE)

(72) Inventors: Hans-Josef Laas, Odenthal (DE); Irene Cristina Latorre Martinez, Leverkusen (DE); Michael Grahl, Leverkusen (DE); Raul Pires, Köln (DE)

(21) Appl. No.: 16/918,029

(22) Filed: Jul. 1, 2020

(30) Foreign Application Priority Data
Jul. 11, 2019 (EP) 19185842.2

(51) Int. Cl. C09D 175/06; C08G 18/20; C08G 18/42; C08G 18/79; C09D 5/03

(52) U.S. Cl. CPC C09D 175/06; C08G 18/2027; C08G 2150/20; C08G 18/798; C09D 5/03; C08G 18/42

(57) ABSTRACT

The invention relates to a polyurethane powder coating material, to the use of such a polyurethane powder coating material, to a method for producing a coating, and to coated substrates.

### CROSS REFERENCE TO RELATED APPLICATIONS

The present application claims priority under the Paris Convention to EP Serial Number 19185842.2, filed Jul. 11, 2019, the entire contents of which are incorporated herein by reference.

### FIELD OF THE INVENTION

Under the pressure of evermore stringent environmental legislation, recent years have seen the development of powder coating materials becoming increasingly important, alongside high-solids coatings and aqueous coating systems. Powder coating materials do not release any harmful solvents at all during application, can be processed with a very high level of materials efficiency, and are therefore considered to be particularly eco-friendly and economical.

### BACKGROUND OF THE INVENTION

Light-resistant and weather-resistant coatings of particularly high quality can be produced using heat-curable, polyurethane-based powder coating materials. The polyurethane (PU) powder coating materials that are presently established in the market generally consist of solid polyester polyols, which are cured using solid, blocked, aliphatic or usually cycloaliphatic polyisocyanates. A disadvantage of these systems, however, is that in the course of the thermal crosslinking, the compounds used as blocking agents are cleaved off and predominantly escape. During their processing, for reasons not only associated with the apparatus but also of environment and occupational hygiene, it is necessary to take special precautions in order to clean the outgoing air and/or to recover the blocking agent.

One way of avoiding the emission of blocking agents is provided by the known PU powder coating crosslinkers which contain uretdione groups (e.g. DE-A 2 312 391, DE-A 2 420 475, EP-A 0 045 994, EP-A 0 045 996, EP-A 0 045 998, EP-A 0 639 598 or EP-A 0 669 353). The crosslinking principle utilized with these products is the thermal cleavage of uretdione groups back into free isocyanate groups and the reaction of the latter with the hydroxy-functional binder. In practice, however, uretdione powder coating crosslinkers have found little use to date. The reason for this lies in the comparatively low reactivity of the internally blocked isocyanate groups, which generally necessitate baking temperatures of at least 160° C.

Although it is known that from about 100° C. there is already marked onset of the splitting of uretdione groups, especially in the presence of hydroxyl-containing reactants, the reaction in this temperature range is still so slow that the complete curing of coating films takes several hours, a time which is unrealistically long for practical use. While DE-A 2 420 475, DE-A 2 502 934 or EP-A 0 639 598 states temperatures as low as 110° C., and in DE-A 2 312 391 even temperatures from 90° C., as possible baking conditions for powder coating systems containing uretdione groups, the working examples specifically described nevertheless show that even with the powder coating materials described in these publications, sufficiently crosslinked coatings are obtainable in practical baking times of not more than 30 minutes only from temperatures of 150 to 160° C. How it is possible to provide powder coating materials which in fact can be fully cured to a commercially utilizable extent at temperatures of just below 150° C. to 160° C. is not disclosed in these publications.

There has been no lack of attempts to accelerate the curing of uretdione-crosslinking PU powder coatings through accompanying use of suitable catalysts. A variety of compounds have already been proposed for this purpose, examples being the organometallic catalysts known from polyurethane chemistry, such as tin(II) acetate, tin(II) octoate, tin(II) ethylcaproate, tin(II) laurate, dibutyltin diacetate, dibutyltin dilaurate, dibutyltin maleate (e.g. EP-A 0 045 994, EP-A 0 045 998, EP-A 0 601079, WO 91/07452 or DE-A 2 420 475), iron(III) chloride, zinc chloride, zinc 2-ethylcaproate and molybdenum glycolate, tertiary amines, such as triethylamine, pyridine, methylpyridine, benzyldimethylamine, N,N-endoethylenepiperazine, N-methylpiperidine, pentamethyldiethylenetriamine, N,N-dimethylaminocyclohexane and N,N′-dimethylpiperazine (e.g. EP-A 0 639 598) or N,N,N′-trisubstituted amidines, especially bicyclic amidines, such as 1,5-diazabicyclo[4.3.0]non-5-ene (DBN) (e.g. EP-A 0 803 524).

Among these catalysts, the stated bicyclic amidines permit the lowest baking temperatures. At the same time, however, they lead to a yellowing on baking that is unacceptably high for many areas of application. For this reason, amidine-catalysed uretdione systems have been unable to date to make inroads into the market.

According to the teaching of EP-A 1 137 689, Lewis acid catalysts, such as the aforementioned tin or zinc compounds, for example, are inhibited by acidic groups, such as carboxyl groups, for example. They can therefore only develop their full catalytic activity in a uretdione powder coating system if the hydroxy-functional binder used is free of carboxyl groups. For this reason, the powder coating materials described in this publication, consisting of customary hydroxy-functional binders, crosslinkers containing uretdione groups, and specific Lewis acid catalysts, are admixed with a sufficient amount of an agent that is reactive toward carboxyl groups, such as an epoxide, for example, in order to bring about complete or near-complete reaction of any carboxyl groups still present in the binder and hence to remove them from the system. In this way, the reactivity of the polyurethane powders can be boosted to a point where the onset of curing is from a temperature of just around 120° C. The coating films obtainable in this case, however, exhibit insufficient flow behavior, as manifested in a strong surface structure and inadequate gloss. While WO 2005/095482 describes improved coating formulas of this kind, which in the presence of zinc catalysts crosslink at low temperatures and yield coatings having acceptable flow, these systems do involve compliance with the use of highly specific hydroxy-functional binders with a precisely defined residual acid group content.

Other catalysts with which it is possible to lower the baking temperature of uretdione powder coating materials in the absence of carboxyl groups or with accompanying use of a compound reactive toward carboxyl groups are, for example, the ammonium hydroxides and ammonium fluorides described in EP-A 1 334 987, the ammonium carboxylates described in EP-A 1 475 399, or the metal hydroxides and metal alkoxides described in EP-A 1 475 400. For complete crosslinking, however, powder coating materials with this kind of catalysis still always require around 30 minutes at baking temperatures of around 160° C.

To date it has not been possible to find a satisfactory solution to the problem of formulating uretdione powder coating materials of high reactivity which are also suitable for the coating of temperature-sensitive substrates such as plastic or wood.

### DETAILED DESCRIPTION OF THE INVENTION

It was an object of the present invention, therefore, to provide new PU powder coating materials, free from elimination products and based on readily available, standard commercial binder components, which cure at very low baking temperatures and/or in appropriately short baking times and do so to give fully crosslinked coating films.

It has now been possible to achieve this object through the provision of the uretdione powder coating materials described in more detail hereinafter.

The present invention is based on the surprising observation that PU powder coating materials free from elimination products and consisting of standard commercial uretdione powder coating crosslinkers and hydroxy-functional binders cure within just a short time at very low temperatures, in the presence of salt-like catalysts having an imidazolium and/or imidazolinium structural element, to give fully crosslinked, solvent-resistant coatings.

A subject of the present invention is a polyurethane powder coating material comprising
A) at least one hydroxy-functional binder component which is present in solid form below 40° C. and in liquid form above 130° C. and has an OH number of 15 to 200 mg KOH/g, a number-average molecular weight of 400 to 10 000 and a carboxyl group (calculated as COOH; molecular weight=45) content of up to 2.0 wt %, optionally
B) at least one monoalcohol or at least one monoalcohol mixture which is present in solid form below 23° C. and in liquid form above 125° C.,
C) at least one polyaddition compound which contains uretdione groups and optionally free isocyanate groups and is based on aliphatic and/or cycloaliphatic diisocyanates,
D) at least one catalyst comprising a structural element of the general formulae (I) and/or (II)

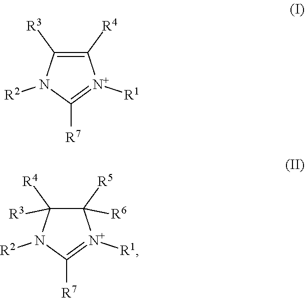

in which
R¹, R², R³, R⁴, R⁵ and R⁶ independently of one another are identical or different radicals which denote saturated or unsaturated, linear or branched, aliphatic, cycloaliphatic, araliphatic or aromatic organic radicals having 1 to 18 carbon atoms, which are substituted or unsubstituted and/or have heteroatoms in the chain, where the radicals, also in combination with one another, may optionally with a further heteroatom form rings having 3 to 8 carbon atoms, which may optionally be further substituted, where
R³, R⁴, R⁵ and R⁶ independently of one another may also be hydrogen, and
R⁷ is hydrogen or a carboxylate anion (COO—),
optionally
E) at least one component which contains groups that are reactive toward carboxyl groups and which has a number-average molecular weight of 200 to 5000,
and optionally
F) further auxiliaries and adjuvants known from powder coating technology,
   with the proviso that components A), B) and C) are present in proportions such that for every hydroxyl group in components A) and B) there are 0.8 to 4.0 isocyanate groups in component
C), the isocyanate groups of component C) being understood as the total of free isocyanate groups and isocyanate groups present in dimeric form as uretdione groups; components A) and optionally E) are present in proportions such that for every carboxyl group in component A) there are 0.8 to 2.0 groups in component E) that are reactive toward carboxyl groups; the fraction of component B) in the total amount of components A) to F) is optionally up to 10 wt %; and the fraction of component D) in the total amount of components A) to F) is 0.05 to 5 wt %.

Another subject of the invention is the use of this powder coating material for coating any desired heat-resistant substrates, i.e. those which at the baking temperatures do not undergo any unwanted changes physically (mechanical properties) or geometrically (shape).

In accordance with the invention, the references to “comprising”, “containing” etc. preferably mean “substantially consisting of” and very preferably “consisting of”. The further embodiments stated in the claims and in the description may be combined as desired unless the contrary is clearly apparent from the context.

Component A) in the powder coating materials of the invention is a hydroxy-functional binder component which is present in solid form below 40° C. and in liquid form above 130° C. and which consists of at least one polymeric polyol.

This comprises any desired binders containing hydroxyl groups and known from powder coating technology, having an OH number of 15 to 200 mg KOH/g, preferably of 25 to 150 mg KOH/g, which may have an average (calculable from the functionality and the hydroxyl content) molecular weight of 400 to 10 000, preferably of 1000 to 5000, and may contain up to 2.0 wt %, preferably up to 1.6 wt %, more preferably up to 1.2 wt % of carboxyl groups (calculated as COOH; molecular weight=45).

Suitable binders are, for example, hydroxyl-containing polyesters, polyacrylates or polyurethanes, as described by way of example as powder coating binders in EP-A 0 045 998 or EP-A 0 254 152, for example, and which may also be used in any desired mixture with one another.

The polyol component A) preferably comprises hydroxyl-containing polyesters of the stated kind or any desired mixtures of such polyester polyols. In a first preferred embodiment, component A) comprises and preferably consists of at least one polyester which contains hydroxyl groups and has an OH number of 25 to 200 and a number-average molecular weight of 1000 to 5000.

Additionally or alternatively it is preferable that these polyester polyols may be amorphous and have softening temperatures (Tg) which—determined by differential thermal analysis (DTA) according to DIN 51007:2019-04—are within the temperature range from 40 to 120° C., more preferably within the temperature range from 45 to 110° C., or else may be semicrystalline and possess melting points (by DTA according to DIN 51007:2019-04) in the range from 40 to 130° C., more preferably in the range from 50 to 100° C.

Amorphous polyester polyols used preferably as polyol component A) are, for example, those as described illustratively in WO 91/07452 on page 8, lines 3 to 29. Semicrystalline polyester polyols used preferably are likewise known and are described for example in WO 91/07452 from page 8, line 30 to page 11, line 25, or in WO 2005/105879 from page 11, line 6 to page 12, line 7.

To improve the flow properties it is possible for the powder coating materials of the invention optionally to comprise monoalcohols or monoalcohol mixtures B) which are in solid form below 23° C. and in liquid form above 125° C.

These are any desired saturated or unsaturated monovalent alcohols which may carry aliphatically, cycloaliphatically or aromatically bonded hydroxyl groups and may optionally contain up to 3 heteroatoms from the series of oxygen, sulfur, and nitrogen. Suitable examples include monoalcohols of the molecular weight range 100 to 900, such as, for example, 1-dodecanol, 1-tridecanol, 1-tetradecanol, 1-pentadecanol, 1-hexadecanol, 1-heptadecanol, 1-octadecanol, (E)-9-octadecen-1-ol, 1-nonadecanol, 1-eicosanol, 1-heneicosanol, 1-docosanol, (E)- and (Z)-13-docosen-1-ol, 1-tricosanol, 1-tetracosanol, 1-pentacosanol, 1-hexacosanol, 1-heptacosanol, 1-octacosanol, 1-nonacosanol, 1-triacontanol, 1-hentriacontanol, 1-dotriacontanol, 1-tetratriacontanol, 2-tetradecylocta-decanol, 2-hexadecyleicosanol, cyclohexanol, 1-methylcyclohexan-1-ol, the isomeric decalols, cyclopentadecanol, 4-octylphenol, 4-tert-octylphenol, isomeric nonylphenols, 1-naphthol, 2-naphthol or any desired mixtures of such alcohols.

Likewise suitable as components B) are homologue mixtures of linear or branched monoalcohols having number-average molecular weights of 200 to 750, of the kind obtained, for example, by known methods in industrial synthesis in the form of primary products, provided that they have a melting range or softening range within the above-stated temperature interval. A comprehensive overview of the industrial methods for producing such monoalcohol mixtures is found for example in K. Noweck: “Fatty Alcohols”, Ullmann's Encyclopedia of Industrial Chemistry, Electronic Release, 7th ed Wiley-VCH, Weinheim June 2001, DOI: 10.1002/14356007.a10_277. Suitable homologous monoalcohol mixtures are obtainable for example by a Ziegler method (Alfol or Epal process), by hydroformylation of O-olefins, e.g. by the SHOP process (“Shell's Higher Olefin Process”), or by various oxidative methods from paraffins, as for example by the Baker Petrolite process (see e.g. U.S. Pat. No. 4,426,329).

Preferred components B) are saturated linear or branched aliphatic monoalcohols having 12 to 50 carbon atoms, mixtures of such monoalcohols, or homologue mixtures of saturated linear or branched monoalcohols containing on statistical average from 18 to 50 carbon atoms, these mixtures having been prepared by one of the aforementioned methods.

Particularly preferred are saturated linear-aliphatic monoalcohols having 12 to 24 carbon atoms and a primary-bonded hydroxyl group, mixtures of such primary monoalcohols, or homologue mixtures of saturated primary monoalcohols containing on statistical average from 23 to 50 carbon atoms, these mixtures having been prepared by one of the aforementioned methods.

In the powder coating materials of the invention, the hydroxy-functional binders A) are combined with a crosslinker component C) that is reactive toward hydroxyl groups. This component comprises polyaddition compounds which are in solid form below 40° C. and in liquid form above 125° C. and which contain uretdione groups and optionally free isocyanate groups, preferably polyaddition compounds based on aliphatic, cycloaliphatic and/or araliphatic diisocyanates, of the kind obtainable in various ways, as for example by phosgenation in the liquid phase or gas phase or by a phosgene-free route, such as by thermal urethane cleavage, for example, and more particularly those based on pentamethylene 1,5-diisocyanate (PDI), hexamethylene 1,6-diisocyanate (HDI), 1-isocyanato-3,3,5-trimethyl-5-isocyanatomethylcyclohexane (isophorone diisocyanate, IPDI), 4,4′- and/or 4,2′-diisocyanatodicyclohexylmethane (H₁₂-MDI), 1,3-diisocyanato-2(4)-methylcyclohexane, bis(isocyanatomethyl)norbornane (NBDI), 1,3- and 1,4-bis(isocyanatomethyl)benzene (xylylene diisocyanate, XDI), or any desired mixtures of these diisocyanates.

Particularly preferred diisocyanates for preparing the crosslinker components C) containing uretdione groups are PDI, HDI, IPDI and H₁₂-MDI.

The preparation of such polyaddition compounds through reaction of polyisocyanates containing uretdione groups with difunctional and optionally monofunctional compounds that are reactive toward isocyanate groups, more particularly divalent and optionally monovalent alcohols, is known in principle and is described for example in DE-A 2 420 475, EP-A 0 045 996, EP-A 0 045 998, EP-A 0 639 598, EP-A 0 669 353, EP-A 1 024 158 or WO 04/005363. The polyaddition compounds contemplated as component B) and containing uretdione groups and optionally free isocyanate groups generally have a uretdione group (calculated as C₂N₂O₂, molecular weight=84) content of 3 to 19 wt % and a free isocyanate group (calculated as NCO; molecular weight=42) content of 0 to 6.0 wt %. The melting point or melting range of these compounds is situated in general within the temperature range from 40 to 125° C.

In another preferred embodiment, component C) comprises and preferably consists of at least one polyaddition compound which contains uretdione groups and optionally free isocyanate groups and which has a minimum carboxylic ester group (calculated as CO₂; molecular weight=44) and/or carbonate group (calculated as CO₃; molecular weight=60) content of 1 wt %. These particularly preferred polyaddition compounds containing uretdione groups are likewise already known. They may be prepared for example as described in EP-A 0 639 598, EP-A 1024 158, EP-B 1 063 251 or WO 04/005363.

Components A), B) and C) are used in the powder coating material of the invention in amounts such that for every hydroxyl group in components A) and B) there are 0.8 to 4.0, preferably 1.0 to 3.0, more preferably 1.2 to 2.0 isocyanate groups of component C), with isocyanate groups of component C) referring to the sum total of free isocyanate groups and isocyanate groups present in dimeric form as uretdione groups, and a fraction of component B) in the total amount of components A) to F) is optionally up to 10 wt %, preferably up to 8 wt %, more preferably up to 7 wt %. Where component B) is used as an accompaniment, the fraction thereof in the total amount of components A) to F) is preferably 0.1 to 10 wt %, more preferably 0.1 to 8 wt % and very preferably 0.1 to 7 wt %.

To accelerate the curing, the powder coating materials of the invention comprise at least one saltlike catalyst D) having an imidazolium and/or imidazolinium structural element, this catalyst accelerating the reaction of uretdione groups with hydroxyl groups.

Compounds suitable as catalysts D) are known in the form of ionic liquids of the imidazolium and imidazolinium types and are employed for example as solvents in chemical synthesis. Processes for preparing them are described for example in Chem. Rev. 99, 8, 2071-2084 and WO 2005/070896.

The catalysts D) are salt-like compounds comprising a structural element of the general formulae (I) and/or (II)

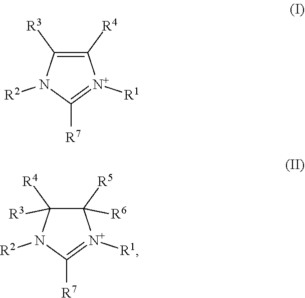

in which
R¹, R², R³, R⁴, R⁵ and R⁶ independently of one another are identical of different radicals which denote saturated or unsaturated, linear or branched, aliphatic, cycloaliphatic, araliphatic or aromatic organic radicals having 1 to 18 carbon atoms, which are substituted or unsubstituted and/or have heteroatoms in the chain, where the radicals, also in combination with one another, may optionally with a further heteroatom form rings having 3 to 8 carbon atoms, which may optionally be further substituted, where
R³, R⁴, R⁵ and R⁶ independently of one another may also be hydrogen, and
R⁷ is hydrogen or a carboxylate anion (COO⁻).

Preferred catalysts D) are salt-like compounds comprising a structural element of the general formulae (I) or (II) in which
R¹ and R² independently of one another are identical or different radicals which denote saturated or unsaturated, linear or branched, aliphatic, cycloaliphatic, araliphatic or aromatic organic radicals having 1 to 12 carbon atoms, which are substituted or unsubstituted and/or have heteroatoms in the chain,
R³, R⁴, R⁵ and R⁶ are hydrogen, and where
R⁷ is hydrogen or a carboxylate anion (COO⁻).

Particularly preferred catalysts D) are salt-like compounds comprising a structural element of the general formulae (I) or (II) in which
R¹ and R² independently of one another are identical or different radicals which denote saturated or unsaturated, linear or branched, aliphatic organic radicals having 1 to 12 carbon atoms,
R³, R⁴, R⁵ and R⁶ are hydrogen, and where
R⁷ is hydrogen or a carboxylate anion (COO⁻).

Illustrative instances of suitable catalysts D) of the general formula (I) include those which comprise a 1,3-dimethylimidazolium, 1-methyl-3-ethylimidazolium, 1-methyl-3-propylimidazolium, 1-methyl-3-butylimidazolium, 1-methyl-3-pentylimidazolium, 1-methyl-3-hexylimidazolium, 1-methyl-3-octylimidazolium, 1-methyl-3-nonylimidazolium, 1-methyl-3-decylimidazolium, 1-decyl-3-methylimidazolium, 1-methyl-3-benzylimidazolium, 1-methyl-3-(3-phenylpropyl)imidazolium, 1-ethyl-3-methylimidazolium (EMIM), 1-isopropyl-3-methylimidazolium, 1-butyl-3-methylimidazolium (BMIM), 1-hexyl-3-methylimidazolium, 1-heptyl-3-methylimidazolium, 1-(2-ethyl)hexyl-3-methylimidazolium (OMIM), 1,3-bis(tert-butyl)imidazolium, 1,3-bis(2,4,6-trimethylphenyl)imidazolium or −1,3-dimethylbenz-imidazolium cation.

Illustrative instances of suitable catalysts D) of the general formula (II) include those which comprise a 1,3-dimethylimidazolinium, 1-ethyl-3-methylimidazolinium, 1-butyl-3-methylimidazolium, 1,3-bis(2,6-diisopropylphenyl)imidazolinium or −1,3-bis(2,4,6-trimethylphenyl)imidazolinium-1-(1-adamantyl)-3-(2,4,6-trimethylphenyl)imidazolinium, 1,3-diphenyl-4,4,5,5-tetramethylimidazolinium or 1,3-di-o-tolyl-4,4,5,5-tetramethylimidazolinium cation.

As the counterion to the imidazolium and imidazolinium cations, the catalysts D) present in the powder coating materials of the invention comprise any desired inorganic and/or organic anions, such as, for example, halide, sulfate, hydroxysulfate, sulfite, nitrate, carbonate, hydrogencarbonate, arylsulfonate, alkylsulfonate, trifluoromethylsulfonate, alkylsulfate, phosphate, dialkylphosphate, hexafluorophosphate, trifluoromethylborate, tetrafluoroborate, bis(trifluoromethylsulfonyl)imide, dicyanamide and/or carboxylate anions.

The counterion to the imidazolium and imidazolinium cations may additionally also represent a carboxylate group (COO⁻) which as R⁷ of the general formula (I) is bonded directly on the imidazolium cation, and in this case the catalyst D) is present in the form of a zwitterionic structure.

Suitable catalysts D) for the powder coating materials of the invention are, for example, 1,3-dimethylimidazolium chloride, 1,3-dimethylimidazolium 2-carboxylate, 1,3-dimethylimidazoliumdimethylphosphate, 1-ethyl-3-methylimidazoliumchloride, 1-ethyl-3-methylimidazolium bromide, 1-ethyl-3-methylimidazolium iodide, 1-ethyl-3-methylimidazolium nitrate, 1-ethyl-3-methylimidazolium hydrogencarbonate, 1-ethyl-3-methylimidazolium methanesulfonate, 1-ethyl-3-methylimidazolium trifluoromethanesulfonate, 1-ethyl-3-methylimidazolium trifluoro(trifluoromethyl)borate, 1-ethyl-3-methylimidazoliumhydrogensulfate, 1-ethyl-3-methylimidazoliumethylsulfate, 1-ethyl-3-methylimidazolium dicyanamide, 1-ethyl-3-methylimidazolium tetrafluoroborate, 1-ethyl-3-methylimidazolium diethylphosphate, 1-ethyl-3-methylimidazolium hexafluorophosphate, 1-ethyl-3-methylimidazolium bis(trifluoromethanesulfonyl)imide, 1-ethyl-3-methylimidazolium 2-carboxylate, 1-ethyl-3-methylimidazolium acetate, 1-ethyl-3-methylimidazolium (L)-(+)-lactate, 1-methyl-3-propylimidazolium iodide, 1,3-diisopropyl-4,5-dimethylimidazolium 2-carboxylate, 1-butyl-3-methylimidazolium chloride, 1-butyl-3-methylimidazolium bromide, 1-butyl-3-methylimidazolium iodide, 1-butyl-3-methylimidazolium trifluoromethanesulfonate, 1-butyl-3-methylimidazolium ethylsulfate, 1-butyl-3-methylimidazolium n-octylsulfate, 1-butyl-3-methylimidazolium dicyanamide, 1-butyl-3-methylimidazolium trifluoro(trifluoromethyl)borate, 1-butyl-3-methylimidazolium tetrafluoroborate, 1-butyl-3-methylimidazolium dibutylphosphate, 1-butyl-3-methylimidazolium hexafluorophosphate, 1-butyl-3-methylimidazolium 2-carboxylate, 1-butyl-3-methylimidazolium acetate, 1-butyl-3-methylimidazolium bis(trifluoromethanesulfonyl)imide, bis(tert-butyl)imidazolium 2-carboxylate, 1-hexyl-3-methylimidazolium chloride, 1-hexyl-3-methylimidazolium bromide, 1-hexyl-3-methylimidazolium tetrafluoroborate, 1-hexyl-3-methylimidazolium bis(trifluoromethanesulfonyl)imide, 1-hexyl-3-methylimidazolium hexafluorophosphate, 1-methyl-3-n-octylimidazolium bromide, 1-methyl-3-n-octylimidazolium chloride, 1-methyl-3-n-octylimidazolium hexafluorophosphate, 1-decyl-3-methylimidazolium bis(trifluoromethanesulfonyl)imide, 1,3-dimethylimidazolinium chloride, 1,3-dimethylimidazolinium 2-carboxylate, 1,3-dimethylimidazolinium acetate, 1-ethyl-3-methylimidazolinium chloride, 1-ethyl-3-methylimidazolinium 2-carboxylate, 1-ethyl-3-methylimidazolinium acetate, 1-butyl-3-methylimidazolinium 2-carboxylate, 1,3-bis(2,6-diisopropylphenyl)imidazolinium chloride or 1,3-bis(2,4,6-trimethylphenyl)imidazolinium-1-(1-adamantyl)-3-(2,4,6-trimethylphenyl)imidazolinium chloride and/or 1,3-diphenyl-4,4,5,5-tetramethylimidazolinium chloride.

Particularly preferred catalysts D) are imidazolium salts of the stated kind with carboxylate anions, very preferably 1,3-dimethylimidazolium 2-carboxylate, 1-ethyl-3-methylimidazolium 2-carboxylate, 1-ethyl-3-methylimidazolium acetate, 1-butyl-3-methylimidazolium 2-carboxylate and/or 1-butyl-3-methylimidazolium acetate.

The stated catalysts D), especially if they are compounds liquid at room temperature, may optionally be employed in a form adsorbed on a solid support, for example an amorphous silicate powder or aluminum oxide powder, for greater ease of handling and improved meterability.

The curing catalysts D) are employed in the powder coating materials of the invention in an amount of 0.05 to 5 wt %, preferably of 0.1 to 3 wt %, based on the total amount of components A) to F).

Component E) present optionally in the powder coating materials of the invention comprises compounds which contain groups that are reactive toward carboxyl groups and which have a number-average molecular weight of 200 to 5000, preferably of 200 to 2000, more preferably of 250 to 1000, of the kind employed generally in powder coating technology as crosslinker components for carboxyl-containing powder coating binders.

Suitable components E) are, for example, the polyepoxides known per se, such as triglycidyl isocyanurate (TGIC) and triglycidyl urazole or oligomers thereof, glycidyl ethers, such as those based on bisphenol A, for example, glycidyl-functional copolymers, such as the known glycidyl methacrylates (GMA resins), for example, and also glycidyl esters, such as those of phthalic acid, terephthalic acid, trimellitic acid, tetrahydrophthalic and hexahydrophthalic acid, for example, or any desired mixtures of such polyepoxides.

Suitable components E) are also, for example, compounds containing β-hydroxyalkylamide groups, of the kind described in EP-A 0 322 834 as crosslinker components for carboxyl-containing polyesters. Such β-hydroxyalkylamides are generally prepared by base-catalyzed reaction of organic polycarboxylic esters with β-hydroxyalkylamines at temperatures up to 200° C. with accompanying distillative removal of the resultant alcohol.

In a further preferred embodiment, component E) is at least one polyepoxide and/or at least one β-hydroxyalkylamide.

Employed preferably as component E) for optional accompanying use, in the powder coating materials of the invention are diglycidyl terephthalate, triglycidyl trimellitate, TGIC or β-hydroxyalkylamides based on saturated dicarboxylic esters having 4 to 12 carbon atoms in the dicarboxylic acid moiety, or any desired mixtures of these compounds. Component E) consists more preferably of mixtures of 70 to 82 wt % of diglycidyl terephthalate and 18 to 30 wt % of triglycidyl trimellitate.

Component E) is used, if at all, in the powder coating material of the invention preferably in amounts such that for every carboxyl group in component A) there is an at least equimolar amount of groups in component E) that are reactive toward carboxyl groups. Optionally, for example when using polyol components A) of particularly low melt viscosity, however, it is also possible for just reaction with a molar deficit amount of groups that are reactive toward carboxyl groups to be enough to eliminate the inhibiting effect of the carboxyl groups, and so the ratio of carboxyl groups to groups that are reactive toward carboxyl groups in the powder coating materials of the invention may be from 0.8 to 2.0, preferably from 1.0 to 1.5, more preferably from 1.0 to 1.3.

The powder coating material of the invention may optionally comprise other auxiliaries and adjuvants F) known from powder coating technology.

These are, for example, customary polyurethane catalysts, such as, for example, aluminium tri(ethylacetoacetate), tin(II) hexanoate, tin(II) n-octanoate, tin(II) 2-ethyl-1-hexanoate, tin(II) ethylcaproate, tin(II) laurate, tin(II) palmitate, dibutyltin(IV) oxide, dibutyltin(IV) dichloride, dibutyltin(IV) diacetate, dibutyltin(IV) dimaleate, dibutyltin(IV) dilaurate, dioctyltin(IV) diacetate, molybdenum glycolate, 1,5-diazabicyclo[4.3.0]non-5-ene or 1,8-diazabicyclo[5.4.0]undec-7-ene, or any desired mixtures of such catalysts.

A further class of catalysts for optional accompanying use are the customary compounds known from the literature and suitable for accelerating the reaction of any carboxyl groups present in component A) with the groups in component E) that are reactive toward carboxyl groups; examples of such catalysts include ammonium salts, such as, for example, tetrabutylammonium chloride, bromide or iodide, tetraethylammonium chloride, bromide or iodide, trimethylbenzylammonium chloride, dodecyldimethyl(2-phenoxyethyl)ammonium bromide or diethyl(2-hydroxyethyl)methylammonium bromide, phosphonium salts, such as, for example, tetrabutylphosphonium chloride, bromide or iodide, tetraethylphosphonium chloride, bromide or iodide, tetramethylphosphonium bromide, octadecyltributylphosphonium bromide, hexadecyltributylphosphonium bromide, catalysts with imidazole structure, such as, for example, imidazole, 2-methylimidazole, 2-methyl-4-ethylimidazole, 2-[(N-benzylanilino)methyl]-2-imidazoline phosphate or 2-benzyl-2-imidazoline hydrochloride, or tertiary amines, such as, for example, N,N-dimethylcyclohexylamine, N,N-diethylcyclohexylamine, N-methylpiperidine, N-methylmorpholine, pentamethyldiethylenetriamine, N,N′-dimethylpiperazine or 1,4-diazabicyclo[2.2.2]octane.

Preferred catalysts F) for optional accompanying use are tetraalkylammonium and/or tetraalkylphosphonium salts, more preferably ammonium and phosphonium salts of the type stated in the preceding paragraph.

These additional catalysts F) are used, if at all, in an amount of up to 4 wt %, preferably up to 2.4 wt %, based on the total amount of components A) to F), with the proviso that the total amount of all catalysts D) and optionally F) present in the powder coating material is 0.05 to 5 wt %, preferably 0.1 to 3 wt %, and the fraction of the saltlike catalysts D) comprising an imidazolium and/or imidazolinium structural element within this total amount of D) and F) is at least 20 wt %.

Further auxiliaries and adjuvants F) for optional accompanying use are, for example, flow control agents, such as polybutyl acrylate or those based on polysilicones, light stabilizers, such as sterically hindered amines, UV absorbers, such as benzotriazoles or benzophenones, pigments, such as titanium dioxide, or else colour stabilizers to counter the risk of overbaked yellowing, such as trialkyl and/or triaryl phosphites optionally containing inert substituents, such as triethyl phosphite, triisodecyl phosphite, triphenyl phosphite or trisnonylphenyl phosphite, for example.

To produce the completed powder coating material, the constituents A), C), D) and optionally B), E) and F) are mixed intimately with one another and then combined in the melt to form a homogeneous material. This may take place in suitable assemblies, examples being heatable kneading apparatus, but preferably by melt extrusion, in which case the extrusion temperature is generally selected such that a maximum of shearing forces acts on the mixture. In order to avoid premature crosslinking of the powder coating material, however, an upper temperature limit of 110° C. ought not to be exceeded here.

The sequence of the combining of the individual components A) to F) in this method is largely freely selectable.

A way of producing a completed powder coating material that is likewise preferred in the context of the present invention is also, for example, to carry out intimate mixing, in a first step, only of some of the individual components, for example only components A), B) and D) or components C) and D) or, for example, components A), B), D) and E), in a melt, preferably during or immediately after the preparation of components A) or C), and to add the remaining components only at a later point in time, in a second step, to the storage-stable, homogeneous material that then results, consisting of components A), B) and D) or C) and D) or of components A), B), D) and E), and to extrude everything jointly. It is also possible, furthermore, to formulate any desired concentrates (masterbatches) of formula constituents, for example those of the monoalcohols B) and/or of the catalysts D) and/or of the crosslinker components E) and/or of further auxiliaries and adjuvants F) in one portion of the binder component A), and then to add them to the remaining components during powder coating production, to form a powder coating material of the invention.

Irrespective of the method selected, the proportions of the individual components A), B), C), D), E) and F) are selected anyway such that, as already observed above, for every hydroxyl group of components A) and B) there are 0.8 to 4.0, preferably 1.0 to 3.0, more preferably 1.2 to 2.0 isocyanate groups in component C), with isocyanate groups of component C) referring to the sum total of free isocyanate groups and isocyanate groups present in dimeric form as uretdione groups, and for every carboxyl group in component A) there are 0.8 to 2.0, preferably 1.0 to 1.5, more preferably 1.0 to 1.3 groups in component E) that are reactive toward carboxyl groups.

A particularly preferred embodiment of the invention is a powder coating material wherein components A), B) and C) are present in proportions such that for every hydroxyl group in components A) and B) there are 1.0 to 3.0 isocyanate groups in component C), the isocyanate groups of component C) being understood as the total of free isocyanate groups and isocyanate groups present in dimeric form as uretdione groups; components A) and optionally E) are present in proportions such that for every carboxyl group in component A) there are 1.0 to 1.5 groups in component E) that are reactive toward carboxyl groups; the fraction of component B) in the total amount of components A) and B) is optionally 0.1 to 7 wt %; and the fraction of component D) in the total amount of components A) to E) is 0.1 to 3 wt %.

After cooling to room temperature and after suitable preliminary comminution, by chopping or coarse grinding, for example, the extruded mass is ground into a powder coating material and freed by sieving from the particle fractions above the desired particle size, for example above 0.1 mm.

The powder coating formulations thus produced can be applied to the substrates to be coated, and this can be done by customary powder application techniques, such as electrostatic powder spraying or fluidized bed sintering, for example. The coatings are cured by heating at temperatures from 100 to 220° C., but preferably at temperatures that are low for polyurethane powder coating materials, of 110 to 160° C., more preferably at temperatures of 120 to 150° C., for a time, for example, of around 5 to 60 minutes.

Consequently, a method for producing a coating wherein a powder coating material of the invention is applied to a substrate by electrostatic powder spraying or fluidized bed sintering and is cured by heating at temperatures from 100 to 220° C. is a further subject of the present invention.

The PU powder coating materials of the invention, which are free from elimination products and comprise salt-like catalysts having an imidazolium and/or imidazolinium structural element, on baking at temperatures as low as 100° C., yield hard, elastic, solvent-resistant and chemical-resistant coatings, which in spite of the low baking temperature are distinguished by very good optical properties, particularly a very good flow.

In accordance with the invention, any desired heat-resistant substrates may be coated, such as those, for example, composed of metals, glass, wood or temperature-stable plastics. The examples which follow serve for further elucidation of the invention.

### EXAMPLES

All percentages relate to percentages by weight.

The NCO contents were determined by titrimetry according to DIN EN ISO 11909:2007-05.

The OH numbers were determined by titrimetry according to DIN EN ISO 4629-2:2015-02 and the acid numbers by titrimetry according to DIN EN ISO 2114:2002-06.

Softening temperatures (Tg) and melting points were determined by differential thermal analysis (DTA) in accordance with DIN 51007:2019-04.

As a measure of the cure rate, determinations were made of the gel times of the powder coating materials according to DIN EN ISO 8130-6:2011-02 at 180 and 200° C.

The resistance to chemicals was tested by means of the acetone test. For this test, a cotton pad soaked with acetone is guided in 50 back-and-forth strokes over the coating uniformly in a track. The evaluation is made according to the school grade principle, from 1 (coating film unchanged) to 5 (coating film dissolved).

### Starting Compounds

### Hydroxy-Functional Binder Component A)

CRYLCOAT 2845 (Allnex Germany GmbH, Wiesbaden, DE), hydroxy-functional polyester resin
OH number: 35 mg KOH/g
Equivalent weight: 1600 g/eq OH
Acid number. 8 mg KOH/g
Carboxyl group content: 0.96%
Glass transition temperature (DTA): 57° C.

### Polyaddition Compound C) Containing Uretdione Groups

CRELAN EF 403 (Covestro Deutschland AG, Leverkusen, DE), cycloaliphatic polyuretdione powder coating curing agent
NCO content, total: 13.5%
Equivalent weight: 310 g/eq NCO
Melting range: around 70-78° C.
Glass transition temperature: 40-55° C.

### Catalyst D)

70 g of 1-ethyl-3-methylimidazolium acetate (97%, Sigma-Aldrich Chemie GmbH, Munich, DE) were stirred together with 100 g of silica gel 60 (Merck KGaA, Darmstadt, DE) in 150 ml of methylene chloride at room temperature for 15 minutes. The solvent was subsequently removed using a rotary evaporator and the residue was dried at 50° C. for 3 hours This gave a free-flowing colorless powder. The active ingredient content was 41%.

### Catalyst D2)

1-Ethyl-3-methylimidazolium 2-carboxylate, prepared by the method described in Chem. Eur. J. 2016, 22, 16292-16303. Colorless crystals, melting point around 120° C.

### Component E) Reactive Toward Carboxyl Groups

ARALDIT PT 910 (Huntsman Advanced Materials (Switzerland) GmbH, Basel), mixture of diglycidyl terephthalate (70 to 82%) and triglycidyl trimellitate (18 to 30%).
Equivalent weight: 150 g/eq epoxide

### Example 1 (Comparative, Unanalyzed)

51.5 parts by weight of the hydroxy-functional polyester resin A) were thoroughly premixed together with 10.0 parts by weight of the polyaddition compound C) containing uretdione groups, corresponding to an equivalent ratio of total NCO to OH of 1:1, and also, as auxiliaries and adjuvants F), with 3.0 parts by weight of a commercial flow control agent (ADDITOL P 896, DSM Fine Chemicals, Sittard, NL), 0.5 part by weight of benzoin and 30.0 parts by weight of a white pigment (KRONOS 2160, Kronos Titan, Leverkusen, DE) in a MIXACO mixer at 2000 rpm for 5 minutes and this premix was then extruded using a twin-screw extruder at a temperature of 105° C. (Zone 1) and 115° C. (Zone 2) and with a screw speed of 250 rpm. The solidified powder coating extrudate was comminuted in a MOULINEX kitchen mixer and then fine-ground in a RETSCH mill with sieve insert at 10 000 rpm. Coarse particle fractions above 150 μm were removed with a sieve.

The gel time of the coating material was 240 s at 180° C. and 160 s at 200° C.

### Example 2 (Comparative, Catalyzed as in WO 2005/095482)

The method described in Example 1 was used to produce a white-pigmented powder coating material, starting from 44.4 parts by weight of the hydroxy-functional polyester resin A), 14.6 parts by weight of the polyaddition compound C) containing uretdione groups, 1.0 part by weight of K-KAT XK 602 (zinc acetylacetonate, King Industries, Waddinxveen, NL) as catalyst, 1.0 part by weight of the component E) reactive toward carboxyl groups, and also, as auxiliaries and adjuvants F), 0.5 part by weight of tetrabutylammonium bromide (Sigma-Aldrich Chemie GmbH, Munich, DE), 3.0 parts by weight of a commercial flow control agent (ADDITOL P 896, DSM Fine Chemicals, Sittard, NL), 0.5 part by weight of benzoin and 35.0 parts by weight of a white pigment (KRONOS 2160, Kronos Titan, Leverkusen, DE).

The equivalent ratio of total NCO to OH was 1.7:1, and the equivalent ratio of carboxyl groups to groups reactive toward carboxyl groups was 1.1:1.

The gel time of the coating material was 65 s at 180° C. and 35 s at 200° C.

### Example 3 (Inventive)

The method described in Example 1 was used to produce a white-pigmented powder coating material, starting from 44.0 parts by weight of the hydroxy-functional polyester resin A), 14.5 parts by weight of the polyaddition compound C) containing uretdione groups, 1.5 parts by weight of the catalyst D1), 1.0 part by weight of the component E) reactive toward carboxyl groups, and also, as auxiliaries and adjuvants F), 0.5 part by weight of tetrabutylammonium bromide (Sigma-Aldrich Chemie GmbH, Munich, DE), 3.0 parts by weight of a commercial flow control agent (ADDITOL P 896, DSM Fine Chemicals, Sittard, NL), 0.5 part by weight of benzoin and 35.0 parts by weight of a white pigment (KRONOS 2160, Kronos Titan, Leverkusen, DE).

The equivalent ratio of total NCO to OH was 1.7:1, and the equivalent ratio of carboxyl groups to groups reactive toward carboxyl groups was 1.1:1.

The gel time of the coating material was 55 s at 180° C. and 25 s at 200° C.

### Example 4 (Inventive)

The method described in Example 1 was used to produce a white-pigmented powder coating material, starting from 44.4 parts by weight of the hydroxy-functional polyester resin A), 14.6 parts by weight of the polyaddition compound C) containing uretdione groups, 1.0 part by weight of the catalyst D2), 1.0 part by weight of the component E) reactive toward carboxyl groups, and also, as auxiliaries and adjuvants F), 0.5 part by weight of tetrabutylammonium bromide (Sigma-Aldrich Chemie GmbH, Munich, DE), 3.0 parts by weight of a commercial flow control agent (ADDITOL P 896, DSM Fine Chemicals, Sittard, NL), 0.5 part by weight of benzoin and 35.0 parts by weight of a white pigment (KRONOS 2160, Kronos Titan, Leverkusen, DE).

The equivalent ratio of total NCO to OH was 1.7:1, and the equivalent ratio of carboxyl groups to groups reactive toward carboxyl groups was 1.1:1.

The gel time of the coating material was 25 s at 180° C. and 15 s at 200° C.

The comparison with the gel times shows the markedly higher reactivity of the powder coating materials of the invention according to Examples 3 and 4 relative to the unanalyzed powder coating material from Example 1 and to the powder coating material with prior-art catalysis from Example 2.

The powder coating materials produced in Examples 1 to 4 were applied electrostatically, using a corona gun at a high voltage of 90 kV, in a film thickness of 80-110 μm to degreased aluminum panels from CHEMETALL, and cured in a forced air oven in each case for 15 minutes at 130° C., 140° C., 150° C. and 160° C. and also in each case for 10 minutes at 160° C., 170° C., 180° C. and 200° C.

The chemical resistance of the coatings was subsequently tested using the acetone test. While the unanalyzed comparative powder coating from Example 1 was fully resistant to acetone only after 10-minute baking at 200° C., which can be equated with complete curing, the comparative powder coating from Example 2 and also the powder coating of the invention from Example 3 showed very good chemical resistance after just 15 minutes at 140° C. The powder coating material catalyzed with catalyst D2) according to the invention, from Example 4, was fully acetone-resistant and therefore fully cured even after just 15-minute baking at 130° C.

1. A polyurethane powder coating material comprising
A) at least one hydroxy-functional binder component which is present in solid form below 40° C. and in liquid form above 130° C. and has an OH number of 15 to 200 mg KOH/g, a number-average molecular weight of 400 to 10 000 and a carboxyl group (calculated as COOH; molecular weight=45) content of up to 2.0 wt %, optionally
B) at least one monoalcohol or at least one monoalcohol mixture which is present in solid form below 23° C. and in liquid form above 125° C.,
C) at least one polyaddition compound which contains uretdione groups and optionally free isocyanate groups and is based on aliphatic and/or cycloaliphatic diisocyanates,
D) at least one catalyst comprising a structural element of the general formulae (I) and/or (II) 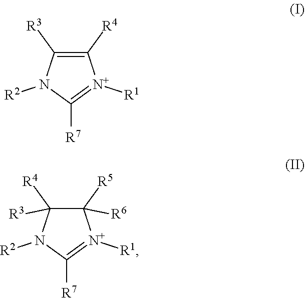
in which
R¹, R², R³, R⁴, R⁵ and R⁶ independently of one another are identical or different radicals which denote saturated or unsaturated, linear or branched, aliphatic, cycloaliphatic, araliphatic or aromatic organic radicals having 1 to 18 carbon atoms, which are substituted or unsubstituted and/or have heteroatoms in the chain, where the radicals, also in combination with one another, may optionally with a further heteroatom form rings having 3 to 8 carbon atoms, which may optionally be further substituted, where
R³, R⁴, R⁵ and R⁶ independently of one another may also be hydrogen, and
R⁷ is hydrogen or a carboxylate anion (COO⁻),
optionally
E) at least one component which contains groups that are reactive toward carboxyl groups and which has a number-average molecular weight of 200 to 5000,
and optionally
F) further auxiliaries and adjuvants known from powder coating technology, with the proviso that components A), B) and C) are present in proportions such that for every hydroxyl group in components A) and B) there are 0.8 to 4.0 isocyanate groups in component C), the isocyanate groups of component C) being the total of free isocyanate groups and isocyanate groups present in dimeric form as uretdione groups; components A) and optionally E) are present in proportions such that for every carboxyl group in component A) there are 0.8 to 2.0 groups in component E) that are reactive toward carboxyl groups; the fraction of component B) in the total amount of components A) to F) is optionally up to 10 wt %; and the fraction of component D) in the total amount of components A) to F) is 0.05 to 5 wt %.

2. The powder coating material according to claim 1, wherein component A) comprises at least one polyester which contains hydroxyl groups and has an OH number of 25 to 200 and a number-average molecular weight of 1000 to 5000.

3. The powder coating material according to claim 1, wherein component A) comprises at least one polyester which contains hydroxyl groups, has a softening temperature (Tg) within the temperature range from 40 to 120° C. and/or is semicrystalline with a melting point in the range from 40 to 130° C.

4. The powder coating material according to claim 1, wherein component C) comprises at least one polyaddition compound which contains uretdione groups and optionally free isocyanate groups and which is based on one selected from the group consisting of pentamethylene 1,5-diisocyanate (PDI), hexamethylene 1,6-diisocyanate (HDI), 1-isocyanato-3,3,5-trimethyl-5-isocyanatomethylcyclohexane (isophorone diisocyanate, IPDI), 4,4′- and/or 4,2′-diisocyanatodicyclohexylmethane (H₁₂-MDI), and mixtures of these diisocyanates.

5. The powder coating material according to claim 1, wherein component C) comprises at least one polyaddition compound which contains uretdione groups and optionally free isocyanate groups and which has a minimum carboxylic ester (calculated as CO₂; molecular weight=44) and/or carbonate (calculated as CO₃; molecular weight=60) group content of 1 wt %.

6. The powder coating material according to claim 1, wherein curing catalyst D) comprises salt-like compounds comprising a structural element of the general formulae (I) or (II) in which
R¹ and R² independently of one another are identical or different radicals which denote saturated or unsaturated, linear or branched, aliphatic, cycloaliphatic, araliphatic or aromatic organic radicals having 1 to 12 carbon atoms, which are substituted or unsubstituted and/or have heteroatoms in the chain,
R³, R⁴, R⁵ and R⁶ are hydrogen,
and where
R⁷ is hydrogen or a carboxylate anion (COO⁻).

7. The powder coating material according to claim 1, wherein curing catalyst D) comprises salt-like compounds comprising a structural element of the general formulae (I) or (II) in which
R¹ and R² independently of one another are identical or different radicals which denote saturated or unsaturated, linear or branched, aliphatic organic radicals having 1 to 12 carbon atoms,
R³, R⁴, R⁵ and R⁶ are hydrogen, and
R⁷ is hydrogen or a carboxylate anion (COO⁻).

8. The powder coating material according to claim 1, wherein curing catalyst D) comprises one selected from the group consisting of 1,3-dimethylimidazolium 2-carboxylate, 1-ethyl-3-methylimidazolium 2-carboxylate, 1-ethyl-3-methylimidazolium acetate, 1-butyl-3-methylimidazolium 2-carboxylate and 1-butyl-3-methylimidazoliumacetate.

9. The powder coating material according to claim 1, wherein component E) comprises polyepoxides and/or β-hydroxyalkylamides.

10. The powder coating material according to claim 1, wherein component E) comprises mixtures of 70 to 82 wt % of diglycidyl terephthalate and 18 to 30 wt % of triglycidyl trimellitate.

11. The powder coating material according to claim 1, wherein component F) comprises at least one selected from the group consisting of tetraalkylammonium salts, and tetraalkylphosphonium salts.

12. The powder coating material according to claim 1, wherein components A), B) and C) are present in proportions such that for every hydroxyl group in components A) and B) there are 1.0 to 3.0 isocyanate groups in component C), the isocyanate groups of component C) being the total of free isocyanate groups and isocyanate groups present in dimeric form as uretdione groups; components A) and optionally E) are present in proportions such that for every carboxyl group in component A) there are 1.0 to 1.5 groups in component E) that are reactive toward carboxyl groups; the fraction of component B) in the total amount of components A) and B) is optionally 0.1 to 7 wt %; and the fraction of component D) in the total amount of components A) to E) is 0.1 to 3 wt %.

13. In a process for coating substrates, the improvement comprising including the powder coating material according to claim 1.

14. A method for producing a coating, comprising applying the powder coating material according to claim 1 by electrostatic powder spraying or fluidized bed sintering to a substrate and is curing by heating at temperatures from 100 to 220° C.

15. A substrate coated with polymer films obtained from the powder coating materials according to the process according to claim 1.
